(19) United States
(12) Patent Application Publication
(10) Pub. No.: US 2026/0278648 A1
(43) Pub. Date: Sep. 17, 2026

(54) Team Fund Tracker

(71) Applicant: Samantha Maria Peterson, Ramsey, MN (US)

(72) Inventor: Samantha Maria Peterson, Ramsey, MN (US)

(21) Appl. No.: 19/076,015

(22) Filed: Mar. 11, 2025

(51) Int. Cl. G06Q 30/0279; G06Q 30/04; G06Q 40/12

(52) U.S. Cl. CPC G06Q 30/0279; G06Q 30/04; G06Q 40/12

(57) ABSTRACT

The present invention discloses a team fund tracking system and digital platform that allows a team within an organization to monitor, manage, and report on the status of funds they are responsible for raising or utilizing. The team fund tracking system, comprising AN artificial Intelligence Apps, real-time tracking module, expense categories modules, an income tracking module, team contributions modules, and alerts and reminders. It provides real-time visibility into the financial health of their projects, initiatives, or specific fundraising campaigns, often with features for collaboration and accountability across team members.

### CROSS REFERENCE TO RELATED APPLICATION

The present application is a Continuation-In-Part application of U.S. patent application No. 63/556,050 filed on 21 Feb. 2024, in favour of the applicant Samantha Peterson which is herein incorporated in its entirety.

### TECHNICAL FIELD

The present invention relates to Artificial Intelligence App in youth sports, and in particular to a team fund tracking system and digital platform that allows a team within an organization to monitor, manage, and report on the status of funds they are responsible for raising or utilizing, providing real-time visibility into the financial health of their projects, initiatives, or specific fundraising campaigns, often with features for collaboration and accountability across team members.

### BACKGROUND ART

There are a number funding trackers App in in the market. A funding tracker template is a pre-designed, customizable tool that helps individuals and organizations effectively manage and monitor their funding sources. It provides a structured format for tracking various aspects of funding, such as income streams, expenses, grants, investments, or donations.

The template allows users to set financial goals, track progress, and generate reports to gain insights into their funding status. With its user-friendly interface and flexibility, the Funding Tracker template serves as a valuable resource for staying organized, making informed financial decisions, and achieving funding objectives efficiently.

There are a few patents on fund tracking systems. The U.S. Pat. No. 10,380,843B2 of 2017 by International Game Technology discloses a system and method for tracking funds from a plurality of funding sources. It relates generally to a system that tracks the funding source of an amount of funds as the funds are transferred between various accounts or balances of various components of the system.

The U.S. Pat. No. 10,776,778B1 of 2018 by Wells Fargo Bank NA discloses a system and method for receipt tracking in a mobile wallet. It reveals a method for receipt tracking performed by one or more processors of a mobile wallet computer system is provided.

The method includes: receiving, by network interface logic of the mobile wallet computer system, a receipt corresponding to a mobile wallet transaction performed by a mobile device associated with a user; extracting, by a receipt tracker of the mobile wallet computer system, identifying information from the receipt; sorting, by the mobile wallet computer system, the identifying information; generating, by the mobile wallet computer system, a user-specific offer based on the sorted identifying information; and providing, by the mobile wallet computer system, the user-specific offer to a mobile device of the user.

However, none of the prior art describes an invention as being proposed in the present disclosure.

Therefore, an enhanced systems and methods of facilitating such tracking transactions would be desirable.

The present team fund tracker is designed to manage youth team's finances effortlessly with the ultimate app specifically for youth sport teams. Whether it is a baseball team, a basketball squad, or any other youth sports group, team fund tracker streamlines financial management and ensures transparency among coaches, parents, and team members.

### OBJECTS OF THE INVENTION

The main object of the present invention is to provide an Artificial Intelligence platform that allows a team in youth sport teams track their funds within a family or organization, monitor, manage, and report on the status of funds they are responsible for raising or utilizing.

The other object of the present invention is to provide a method of tracking team fund for youth sports within a family or organization.

This summary is not an extensive overview of the invention and does not intend to limit the scope beyond what is described and claimed as a summary.

### SUMMARY OF THE INVENTION

In brief, the present invention presents an Artificial Intelligence platform that allows a team in youth sport teams track their funds within a family or organization, monitor, manage, and report on the status of funds they are responsible for raising or utilizing.

In another embodiment, the present invention provides a method of tracking team fund for youth sports within a family or organization.

In another embodiment, the present invention relates to Artificial Intelligence in youth sports, and in particular to a team fund tracking system and digital platform that allows a team within an organization to monitor, manage, and report on the status of funds they are responsible for raising or utilizing, providing real-time visibility into the financial health of their projects, initiatives, or specific fundraising campaigns, often with features for collaboration and accountability across team members.

Under team tracker, funds are collected when each family in a team contributes money to cover additional tem expenses of this application is to provide a platform for parents and managers to have clear visibility into the team's finances. Managers can easily register their team on the app, add team members, record expenses, and communicate with the team through a chat feature. The expense tracker will enable parents to view the team's financial balance and view the breakdown of expenses.

### BRIEF DESCRIPTION OF THE DRAWING

The novel features believed to be characteristic of the illustrative embodiments are outlined in the appended claims. The illustrative embodiments, however, as well as a preferred mode of use, further objectives, and descriptions thereof, will best be understood by reference to the following detailed description of one or more illustrative embodiments of the present disclosure when read in conjunction with the accompanying drawings.

FIG. 1 is a block diagram illustrating a team fund tracking system and digital platform that allows a team within an organization according to some embodiments of the present invention.

FIG. 2 is a block diagram illustrating a method of tracking team fund for youth sports within a family or organization as described in the present invention.

FIG. 3A is a mobile phone interface illustrating login/create of tracking fund for the youth sports team within a family or organization as described in the present invention.

FIG. 3B is a mobile phone interface illustrating username and password of tracking fund for the team of youth sports within a family or organization as described in the present invention.

FIG. 3C is a mobile phone interface illustrating profile type of tracking fund for the team of youth sports within a family or organization as described in the present invention.

FIG. 4A is a parent display of a mobile phone interface of tracking fund for the team of youth sports within a family or organization as described in the present invention.

FIG. 4B is a parent display of a mobile phone interface of tracking fund for the team of youth sports within a family or organization as described in the present invention.

FIG. 5A is a parent display of a mobile phone interface illustrating messenger center of tracking fund for the team of youth sports within a family or organization as described in the present invention.

FIG. 5B is a parent display of a mobile phone interface illustrating expense tracker of tracking fund for the team of youth sports within a family or organization as described in the present invention.

FIG. 6A is a manager display of a mobile phone interface illustrating create team of tracking fund for the team of youth sports within a family or organization as described in the present invention.

FIG. 6B is a manager display of a mobile phone interface illustrating manager dashboard of tracking fund for the team of youth sports within a family or organization as described in the present invention.

FIG. 7A is manager display of a mobile phone interface illustrating team logo of tracking fund for the team of youth sports within a family or organization as described in the present invention.

FIG. 7B is manager display of a mobile phone interface illustrating kid's name of tracking fund for the team of youth sports within a family or organization as described in the present invention.

FIG. 8A is a manager display of a mobile phone interface that illustrates message center of the tracking fund for the youth sports team within a family or organization as described in the present invention.

FIG. 8B is a manager display of a mobile phone interface that illustrates expense tracker balance of the tracking fund for the youth sports team within a family or organization as described in the present invention.

FIG. 8C is a manager display of a mobile phone interface that illustrates where to add a new feature of the tracking fund for the youth sports team within a family or organization as described in the present invention.

### DESCRIPTION OF THE INVENTION

In the following detailed description of the invention, numerous details, examples, and embodiments of the invention are described. However, it will be clear and apparent to those knowledgeable in the field that the invention is not limited to the embodiments set forth and that the invention can be adapted for a wider range of applications.

In this description, the terms “comprising,” “including,” “containing,” “characterized by,” and grammatical equivalents thereof are inclusive or open-ended terms that do not exclude additional, un-recited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

The singular forms “a,” “an,” and “the” are intended to include the plural forms as well, unless the context clearly indicates otherwise.

The term “and/or” includes any and all combinations of one or more of the associated listed items. As used herein, relational terms, such as “first,” “second,” “top,” “bottom,” “upper,” “lower,” “over,” “under,” etc., are used for clarity and convenience in understanding the disclosure and do not connote or depend on any specific preference, orientation, or order, except where the context clearly indicates otherwise.

The present invention teaches about an Artificial Intelligence App in youth sports. It provides a team fund tracking system and digital platform that allows a team within an organization to monitor, manage, and report on the status of funds they are responsible for raising or utilizing, providing real-time visibility into the financial health of their projects, initiatives, or specific fundraising campaigns, often with features for collaboration and accountability across team members.

The team fund tracker is designed to manage youth team's finances effortlessly with the ultimate app specifically for youth sport teams. Whether it is a baseball team, a basketball squad, or any other youth sports group, team fund tracker streamlines financial management and ensures transparency among coaches, parents, and team members.

Under team tracker, funds are collected when each family in a team contributes money to cover additional tem expenses of this application is to provide a platform for parents and managers to have clear visibility into the team's finances. Managers can easily register their team on the app, add team members, record expenses, and communicate with the team through a chat feature. The expense tracker will enable parents to view the team's financial balance and view the breakdown of expenses.

### Key Features

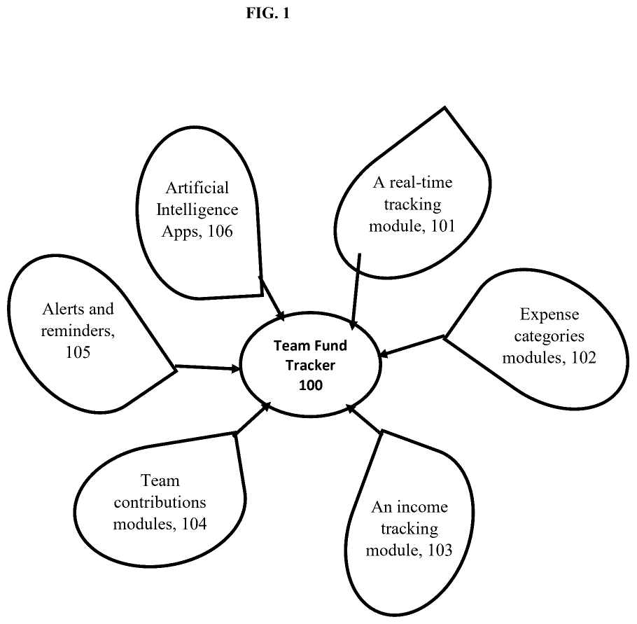

In FIG. 1, the invention comprises the following features: Real-Time Tracking 101: Monitor all team expenses and income in real time, keeping everyone up-to-date with the latest financial status. Expense Categories 102: Easily categorize expenses such as equipment, uniforms, travel, and tournament fees for better organization and clarity. Income Tracking 103: Record and track various sources of income including donations, fundraising events, and sponsorships. Team Contributions 104: Allow parents and team members to track their contributions or payments directly through the app. Alerts and Reminders 105: Receive notifications for upcoming payments, budget limits, or financial milestones to keep everyone informed and prepared.

Artificial Intelligence Apps 106: Comprising a digital platform that allows a team within an organization to monitor, manage, and report on the status of funds they are responsible for raising or utilizing, providing real-time visibility into the financial health of their projects, initiatives, or specific fundraising campaigns, often with features for collaboration and accountability across team members.

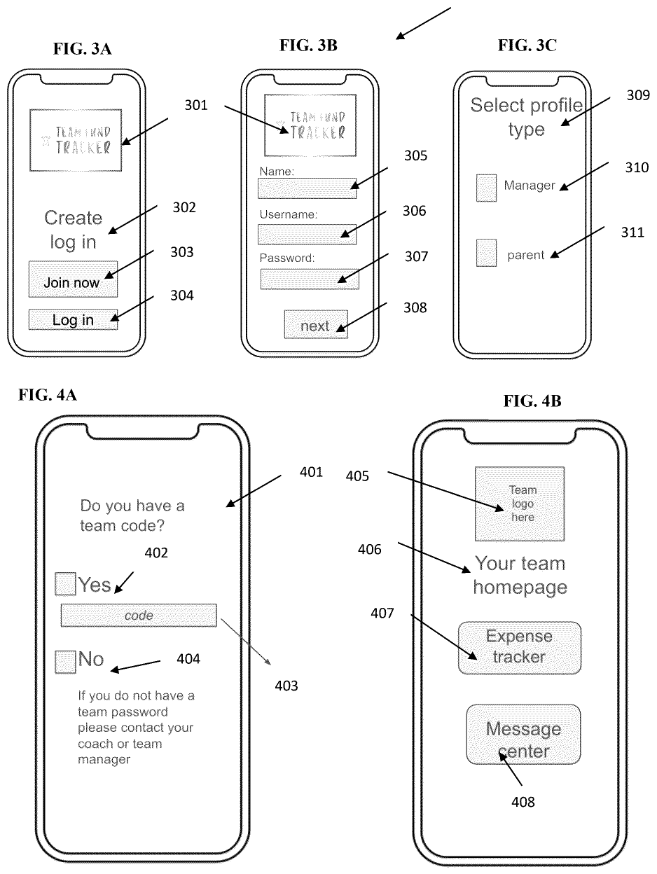

FIG. 3A is a mobile phone interface illustrating login/create of tracking fund for the youth sports team within a family or organization. It comprises a team tracker fund window 301, a provision to create login at position 302, which provides options to join now 303 and log in 304.

In FIG. 3B, the invention presents a mobile phone interface illustrating username and password of tracking fund for the team of youth sports within a family or organization that has a team fund tracker 301 with provisions for a name at place 305, username 306, password 307 and option for next activity 308.

FIG. 3C is a mobile phone interface illustrating profile type of tracking fund for the team of youth sports within a family or organization, which comprises a window to select profile type 309, manager 310 and parent 311.

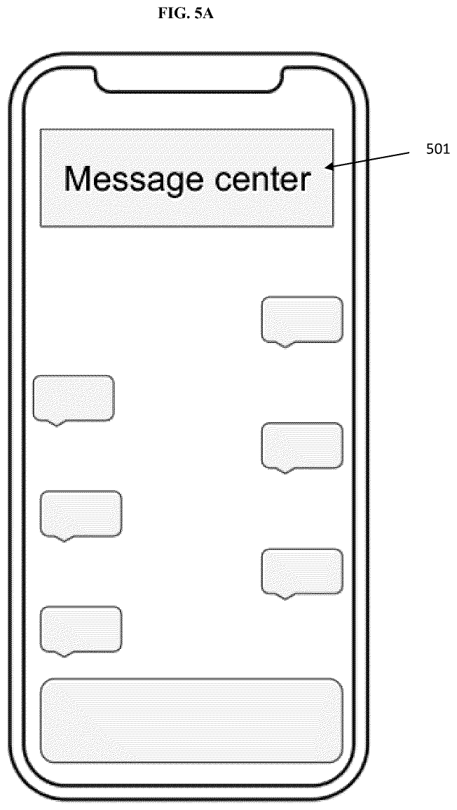

FIG. 4A is a parent display of a mobile phone interface of tracking fund for the team of youth sports within a family or organization. The interface has a query on awareness about the team code at position 401 and if the answer is yes at location 402, the user has the option to enter a code at position 403 send to managers who upon receipt of a unique identifier code will give to parents for their private team. But if the answer is no meaning the user lacks a password as seen in position 404, the App will direct the new user to his coach or team manager. In FIG. 4B is a parent display of a mobile phone interface of tracking fund for the team of youth sports within a family or organization, which has a place for team logo 405, user's team homepage 406, expense tracker 407 and message center 408.

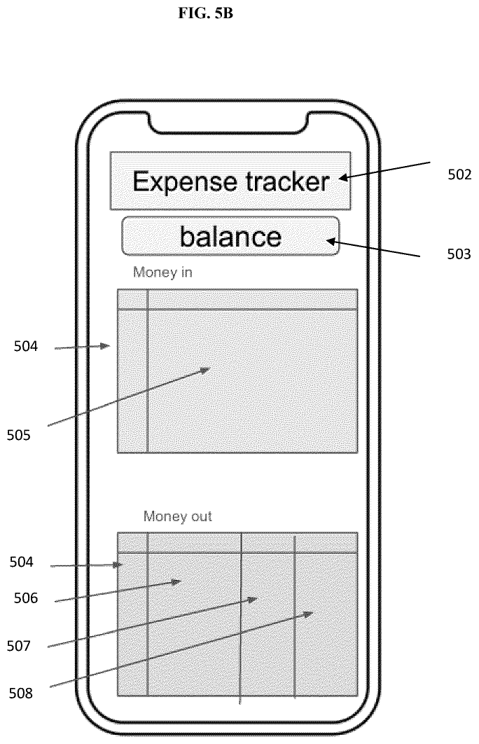

In another embodiment according to FIG. 5A, the invention presents a parent display of a mobile phone interface illustrating the messenger center of tracking fund for the youth sports team within a family or organization with a message center 501. Here parents will be in a chat that all other parents from the team and the manger can view and respond to. In FIG. 5B, the invention provides for a parent display of a mobile phone interface illustrating expense tracker of tracking fund for the team of youth sports within a family or organization showing expense tracker 502 and cash balance at 503. In the expense tracker, parents will be able to view when someone has paid their team fund but will not be able to see who paid. This eliminates the animosity to other parents that are late or are not able to afford the fund. In a similar embodiment, FIG. 5B has a provision for date 504A, amount added 505 and money out also showing the date 504B, amount charged 506, description 507 and attachment upload at position 508. In the money out table, parents will be able to view what amount was spent and view a receipt for that charge. A running balance will be located at the top.

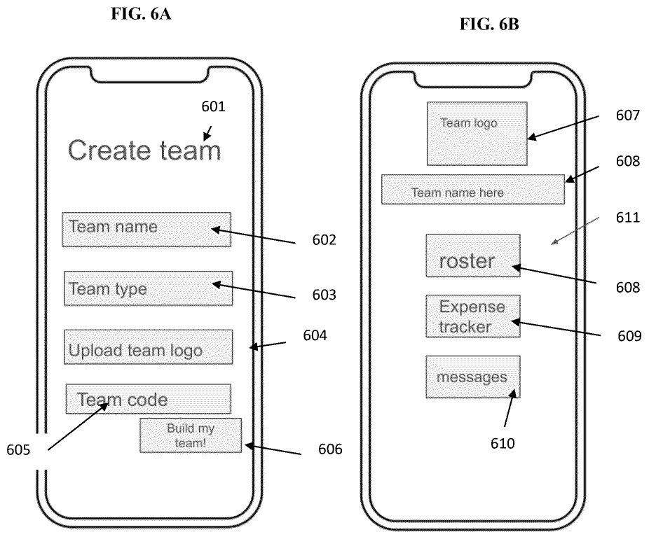

Turning to FIG. 6A, the present invention presents a manager display of a mobile phone interface illustrating create team of tracking fund for the team of youth sports within a family or organization with a provision for create team 601, team name 602, team type 603, upload team logo 604, team code and a place for build my team 606. Here, the manager will be prompted to create their 601, upload a logo 604, upload a roster and input expenses. Team type 603 drop down menu of sports will pop up. After entering a team code 605, the system will generate a unique identifier that will be provided to the manager to give to parents. FIG. 6B presents a manager display of a mobile phone interface illustrating manager dashboard of tracking fund for the team of youth sports within a family or organization and shows team logo at the position 607, team name at 608, manager dashboard 611, roster 608, expense tracker 609 and messages at location 610.

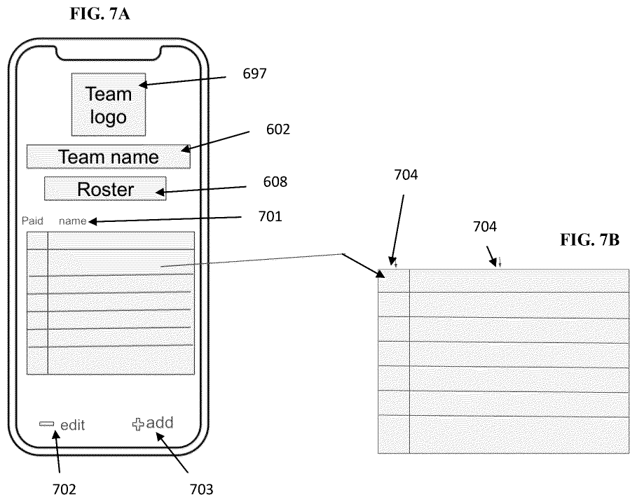

FIG. 7A demonstrates a manager display of a mobile phone interface illustrating team logo of tracking fund for the team of youth sports within a family or organization prominently showing team logo 607, team name 602 and roster 608. It also demonstrates the location paid name 701, location edit 702 and add 703 at the bottom of the screen interface. FIG. 7B is manager display of a mobile phone interface illustrating kid's name of tracking fund for the team of youth sports within a family or organization indicating that managers will be able to check off when a child's team fund is paid at location 704 and kid's name at position 705.

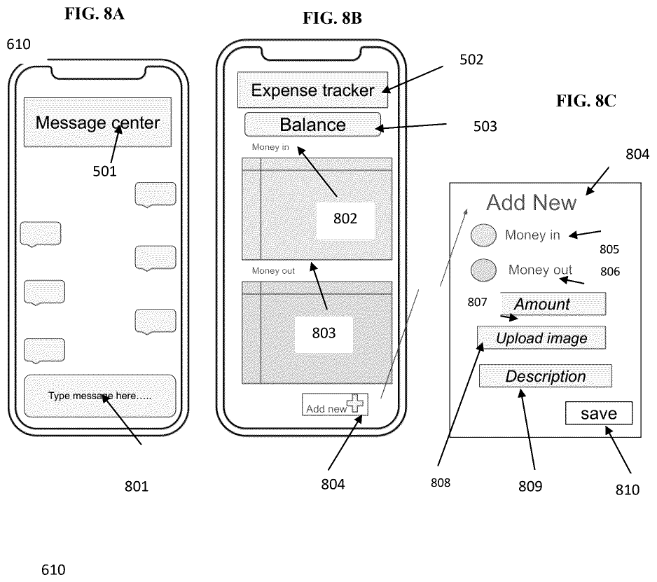

Yet in FIG. 8A, the invention demonstrates a manager display of a mobile phone interface that illustrates message center of the tracking fund for the youth sports team within a family or organization with a message center 501 and type message location at position 801. All members of the team once signed up will see messages in the chat. In FIG. 8B, the invention presents a manager display of a mobile phone interface that illustrates expense tracker balance of the tracking fund for the youth sports team within a family or organization indication expense tracker 502, balance 503, money in at place 802, money out 803 and an add on icon at position which is magnified in FIG. 8C. FIG. 8C is a manager display of a mobile phone interface that illustrates where to add a new feature of the tracking fund for the youth sports team within a family or organization showing money in 805, money out 806, amount 807, upload image 808, description 809 and a position for save 810.

Simplify the team's financial management and focus more on what really matters playing and supporting the game.

The system is designed to enable the user view team balance, team messages, add expenses, log payments and donations, pay monthly subscription, free Adverts, view all team notes, view receipts and download PDF of expenses.

### How to Use the Funding Tracker

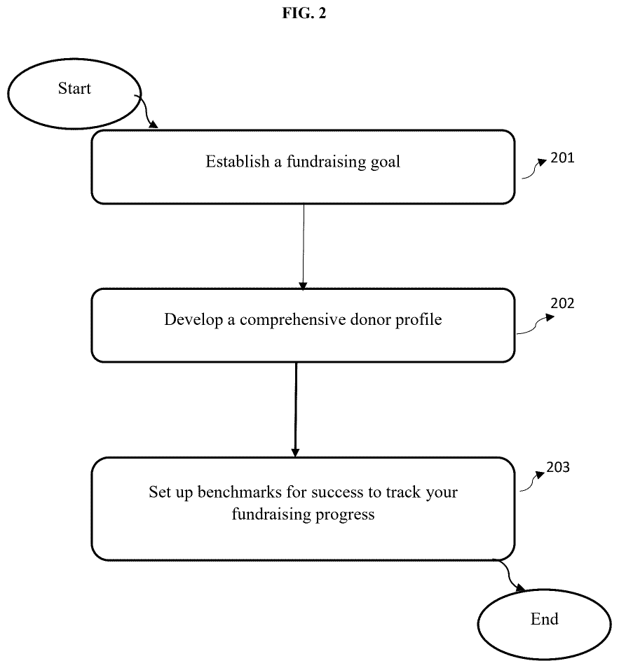

The funding tracker 100 helps the user raise money. It provides an easy-to-use format to track progress towards a fundraising goal as shown in FIG. 2. Here are some factors to keep in mind:
Step 1: Establish a fundraising goal that aligns with your organization's objectives and the nature of your funding needs as at step 101. Consider what you aim to achieve with the funds raised. Understanding your organization's unique circumstances will help you set a realistic funding goal. Additionally, research similar organizations or projects that have sought funding in the past to gain insights and use them as a reference point in anchoring your goals.
Step 2: Develop a comprehensive donor profile by further refining the characteristics of your potential donors as at step 102. Determine the average donation amount you anticipate, as well as the upper and lower bounds of contributions. This donor profile will help you gauge the financial expectations and tailor your fundraising strategies accordingly. By understanding your target donors, you can effectively plan and approach them with compelling messages that resonate with their interests and motivations.
Step 3: Set up benchmarks for success to track your fundraising progress as at step 103. Visualize your funding tracker as a thermometer, with the lowest expected funding amount at the bottom and the upper bound at the top. Divide the space in between with significant milestones that represent specific funding levels or achievements. These benchmarks serve as checkpoints to monitor your progress and keep your team motivated. If you share the funding tracker with the public or potential donors, this visual representation can also inspire them to contribute and help you reach your goals.

### Why Create a Funding Tracker?

Creating a funding tracker serves several purposes and benefits. Firstly, it helps you maintain a clear overview of your funding sources, whether it's for personal finance, a business venture, or a nonprofit organization. By tracking your funding, you can monitor income streams, identify patterns, and make informed decisions regarding budgeting, expenses, and financial planning. Additionally, a Funding Tracker allows you to set specific goals and milestones, providing motivation and direction towards achieving your funding targets. It also enables you to track the progress of fundraising campaigns, grants, or investment rounds, ensuring transparency and accountability. Overall, a Funding Tracker empowers you to make better financial decisions, stay organized, and ultimately increase your chances of financial success.

### When to Use the Funding Tracker

The Funding tracker template is a valuable tool to use when you want to keep track of your funding progress and financial goals. Whether you're an entrepreneur seeking investment, a nonprofit organization managing grants, or an individual tracking personal funding sources, this template helps you stay organized and monitor your financial progress. With its user-friendly interface and customizable features, you can easily input and track funding sources, set milestones, and monitor your overall financial health. The Funding Tracker template is designed to streamline your financial management process and support you in achieving your funding objectives efficiently.

The present invention describes a team fund tracking system is a digital platform or system that allows a team within an organization to monitor, manage, and report on the status of funds they are responsible for raising or utilizing, providing real-time visibility into the financial health of their projects, initiatives, or specific fundraising campaigns, often with features for collaboration and accountability across team members.

### Requirements

a. Keep balance of team funds for team to view
b. Ability for manager to add payments from parents into a database
c. Ability for the manager to enter expenses
d. Ability for managers to upload images for receipts
e. Ability for parents and manager to have a chat to communicate about finances
f. Ability to track the date created
g. Ability to create an account to view private team
h. Ability for all parents and manager to view and respond to messages in the chat
i. Ability for managers to add, edit and delete members from group
j. Ability for manager to create team

### Key Features of a Team Fund Tracking System:

Centralized data storage: All fundraising information, including donor details, donation amounts, project budgets, and spending records, are stored in one accessible location.
Real-time updates: Allows team members to see updated financial data as donations come in or expenses are incurred, enabling proactive decision-making.
Individual project tracking: Enables tracking of funds for specific projects or initiatives within a team, with the ability to allocate budgets and monitor progress against targets.
Role-based access: Different levels of access can be assigned to team members based on their roles, ensuring data security and proper authorization.
Reporting capabilities: Generates customized reports for monitoring fundraising progress, budget performance, and donor engagement, including visuals like charts and graphs.
Collaboration tools: Facilitates communication and collaboration between team members through features like task assignments, comments, and notifications regarding fundraising activities.

### Benefits of Using a Team Fund Tracking System:

Improved efficiency: Streamlines the fundraising process by automating data entry and providing easy access to critical information.
Enhanced accountability: Enables clear visibility into how funds are being used and who is responsible for each aspect of fundraising.
Better decision-making: Provides real-time data to make informed decisions about resource allocation and campaign strategies.
Donor relationship management: Helps maintain accurate donor records and track engagement, leading to improved donor retention.

### Examples of Applications:

Non-profit organizations: Tracking donations for different fundraising campaigns, allocating funds to various projects, and monitoring progress towards fundraising goals.
Sales teams: Monitoring individual sales performance, tracking commission payouts, and visualizing sales pipeline.
Event planning teams: Managing event budgets, tracking ticket sales, and allocating expenses for different aspects of an event.

While the invention has been described with reference to numerous specific sensors, one of ordinary knowledge in the field will recognize that the invention can be embodied in other specific forms without departing from the spirit of the invention. Specific operations may not be performed in one continuous series of operations, and different specific operations may be performed in different embodiments. Furthermore, the processes or methods could be implemented using several sub-processes, or as part of a larger macro process. Thus, one of ordinary knowledge in the field would understand that the invention is not to be limited by the foregoing illustrative details, but rather is to be defined by the appended claims.

### INDUSTRIAL APPLICATION

The present invention relates to Artificial Intelligence Apps in youth sports. It introduces a team fund tracking system and digital platform that allows a team within an organization to monitor, manage, and report on the status of funds they are responsible for raising or utilizing, providing real-time visibility into the financial health of their projects, initiatives, or specific fundraising campaigns, often with features for collaboration and accountability across team members. The system provides a lot of benefits including improved efficiency as it streamlines the fundraising process by automating data entry and providing easy access to critical information, and enhanced accountability since it enables clear visibility into how funds are being used and who is responsible for each aspect of fundraising.

What is claimed is:

1. A team fund tracking system, comprising:
artificial Intelligence Apps;
a real-time tracking module;
expense categories modules;
an income tracking module;
team contributions modules, and
alerts and reminders,
wherein, the team fund tracking system is designed to allow a team within an organization to monitor, manage, and report on the status of funds they are responsible for raising or utilizing across team members.

2. The team fund tracking system according to claim 1, wherein the artificial intelligence Apps further comprises a digital platform that allows a team within an organization to monitor, manage, and report on the status of funds they are responsible for raising or utilizing, providing real-time visibility into the financial health of their projects, initiatives, or specific fundraising campaigns, often with features for collaboration and accountability across team members.

3. The team fund tracking system according to claim 2, wherein digital platform enables:
funds are collected when each family in a team contributes money to cover additional tem expenses of this application is to provide a platform for parents and managers to have clear visibility into the team's finances;
managers can easily register their team on the app, add team members, record expenses, and communicate with the team through a chat feature, and
the expense tracker to enable parents to view the team's financial balance and view the breakdown of expenses.

4. The team fund tracking system according to claim 1, wherein the real-time tracking module is designed to monitor all team expenses and income in real time, keeping everyone up-to-date with the latest financial status.

5. The team fund tracking system according to claim 1, wherein the expense categories module easily categorize expenses such as on equipment, uniforms, travel, and tournament fees for better organization and clarity.

6. The team fund tracking system according to claim 1, wherein the income tracking module is crafted to record and track various sources of income including donations, fundraising events, and sponsorships.

7. The team fund tracking system according to claim 1, wherein the team contributions module allows parents and team members to track their contributions or payments directly through the app.

8. The team fund tracking system according to claim 1, wherein the alerts and reminders modules are designed to receive notifications for upcoming payments, budget limits, or financial milestones to keep everyone informed and prepared.

9. The team fund tracking system according to claim 1, wherein the platform is able to simplify team's financial management and focus more on what really matters-playing and supporting the game.

10. The team fund tracking system according to claim 9, wherein the system is designed to enable the user view team balance, team messages, add expenses, log payments and donations, pay monthly subscription, free Adverts, view all team notes, view receipts and download PDF of expenses.

11. A method of applying a team fund tracking system, comprising steps of;
a. establishing a fundraising goal that aligns with your organization's objectives and the nature of your funding needs by considering what you aim to achieve with the funds raised;
b. understanding your organization's unique circumstances will help you set a realistic funding goal.
c. conducting research in similar organizations or projects that have sought funding in the past to gain insights and use them as a reference point in anchoring your goals;
d. developing a comprehensive donor profile by further refining the characteristics of your potential donors;

12. The method according to claim 11, wherein there is step of determining the average donation amount you anticipate, as well as the upper and lower bounds of contributions, wherein the donor profile will help you gauge the financial expectations and tailor your fundraising strategies accordingly so that by understanding your target donors, you can effectively plan and approach them with compelling messages that resonate with their interests and motivations.

13. The method according to claim 12, wherein there is an additional step of setting up benchmarks for success to track your fundraising progress to visualize your funding tracker as a thermometer, with the lowest expected funding amount at the bottom and the upper bound at the top.

14. The method according to claim 13, wherein there is an additional step of dividing the space in between with significant milestones that represent specific funding levels or achievements so that such benchmarks serve as checkpoints to monitor your progress and keep your team motivated, and if you share the funding tracker with the public or potential donors, this visual representation can also inspire them to contribute and help you reach your goals.

15. A team fund tracking system, comprising artificial Intelligence Apps, real-time tracking module, expense categories modules, an income tracking module, team contributions modules, and alerts and reminders designed to show on a mobile phone interface login/create of tracking fund for the youth sports team within a family or organization, further comprising: a team tracker fund window, provision to create login at position, which provides options to join now and log in.

16. The team fund tracking system according to claim 15, wherein the mobile phone interface is designed to:
a. prompt username and password of tracking fund for the team of youth sports within a family or organization that has a team fund tracker with provisions for a name, username, password and option for next activity,
b. profile type, manager and parent;
c. a query on awareness about the team code and if the answer is yes, the user has the option to enter a code and send to managers who upon receipt of a unique identifier code will give it to parents for their private team, and if the answer is no meaning the user lacks a password, the App will direct the new user to his coach or team manager. and
d. a parent display of a mobile phone interface for team logo, user's team homepage, expense tracker and message center.

17. The team fund tracking system according to claim 16, wherein the parent display of a mobile phone interface has a message center where parents will be in a chat that all other parents from the team and the manger can view and respond to in addition to providing an icon for expense tracker and cash balance, wherein in the expense tracker, parents will be able to view when someone has paid their team fund but will not be able to see who paid being able to eliminate the animosity to other parents that are late or are not able to afford the fund.

18. The team fund tracking system according to claim 17, wherein the interface shows a provision for date, amount added and money out with a date, amount charged, description and attachment upload, wherein in the money out table, parents will be able to view what amount was spent and view a receipt for that charge. A running balance will be located at the top.

19. The team fund tracking system according to claim 18, wherein:
the interface is designed to create team, team name, team type, upload team logo, team code and a place for build my team, wherein the managers will be prompted to create their team, upload a logo, upload a roster and input expenses;
the team type drop down menu of sports will pop up and after entering a team code, the system will generate a unique identifier that will be provided to the manager to give to parents;
manager dashboard of tracking fund for the team of youth sports within a family or organization shows team logo at the position, team name, manager dashboard, roster, expense tracker and messages;
team logo, team name and roster, paid name, capabilities of checking off when a child's team fund is paid and kid's name, and
all members of the team once signed up will see messages in the chat, expense tracker, balance, money in, money out and an add on icon, money in, money out, upload image, description and save.
